(19) United States
(12) Patent Application Publication
(10) Pub. No.: US 2014/0298695 A1
(43) Pub. Date: Oct. 9, 2014

(54) FOLDABLE AND SECURABLE DISPLAY DEVICE

(71) Applicants: Jeff Baker, Orlando, FL (US); Mark Bunker, Winter Garden, FL (US)

(72) Inventors: Jeff Baker, Orlando, FL (US); Mark Bunker, Winter Garden, FL (US)

(21) Appl. No.: 14/245,580

(22) Filed: Apr. 4, 2014

Related U.S. Application Data
(60) Provisional application No. 61/808,298, filed on Apr. 4, 2013.

(51) Int. Cl. G09F 27/00; G09F 13/00; G09F 19/00

(52) U.S. Cl. CPC G09F 27/00; G09F 19/00; G09F 13/005
USPC 40/541; 40/584

(57) ABSTRACT

A display device is provided in an embodiment herein, including an open position and a closed position. The device may include a planar body with contiguous panels including a first panel, a second panel, a third panel, and a fourth panel, and an attachment component provided on each of the first and third panels. This is such that when the first and third panels are urged together to place the display device in the closed position, the attachment components associate with one another whereby the outer sides of the first and third panels are substantially aligned in the closed position, and the second and fourth panels fold, whereby the outer sides of the second and fourth panels are interior to the attachment components in the closed position. The device may include multiple strata, and light, sound, smell, or taste emitting members. Furthermore, the device may include a textured portion.

### CROSS REFERENCE TO RELATED APPLICATIONS

This application claims priority to and incorporates by reference the contents of Provisional Application No. 61/619,979, filed on Apri. 4, 2012 and Provisional Application No. 61/808,298 filed on Apr. 4, 2013 to which priority is claimed under 35 USC 119(e).

### FIELD OF THE INVENTION

The present invention is related displays. In particular, this invention relates to portable foldable displays that can be secured when in a closed position by an attachment component.

### BACKGROUND

Conveying information to educate or advertise can be accomplished by displays that employ any number of techniques to provide portability and ease of use. Often these displays incorporate eye-catching graphics as part, or all, of the information. Some displays are large, some small, however, there remains a demand for a display device that can incorporate the benefits of a large display including the ability to provide more information to the user, as well as the portability and ease of storage of a small display. As a result, there remains a demand for improvements in the art.

### BRIEF DESCRIPTION OF THE INVENTION

An embodiment of the invention is directed toward a display device, including an open position and a closed position, a planar body which forms a quadrilateral in one embodiment. The planar body including contiguous panels, comprising four panels in one embodiment, including a first panel, a second panel, a third panel, and a fourth panel. Each of the first, second, third and fourth panels includes four sides of substantially equal length, two inner sides and two outer sides, each panel being connected at each inner side to an inner side of an adjacent panel; the first and third panels being substantially similar in size, and the second and fourth panels being substantially similar in size, wherein the first and third panels are greater in height and width than the second and fourth panels, the second and fourth panels each including a diagonal fold line extending from a point between the two outer sides of the second and fourth panels to a point between their two inner sides. The display device further includes an attachment component provided on the first and third panels; such that when the display device is in the open position, the display device forms one layer, and when the display device is in the closed position, the device forms three layers, wherein the second and fourth panels fold along the diagonal fold line forming a second layer, and the first and third panels form a first layer and a third layer, respectively, and the attachment components provide for attachment between the first and third layers.

Another embodiment of the invention is directed toward a display device including an open position and a closed position; a planar body including contiguous panels, the planar body comprising a first panel, a second panel, a third panel, and a fourth panel. Alternatively, the display device may be formed of four or more individual sections of material joined together at at least two sides of each section to form the display device. The display device further including an attachment component provided on each of the first and third panels, such that when the first and third panels are urged together to place the display device in the closed position, the attachment components associate with one another whereby the outer sides of the first and third panels are substantially aligned in the closed position of the display device, and the second and fourth panels fold, whereby the outer sides of the second and fourth panels are interior to the attachment components in the closed position of the display device.

Another embodiment of the invention is directed toward a method for displaying information, including a display device comprising a planar body, the planar body comprising contiguous panels, comprising a first panel, a second panel, a third panel, and a fourth panel, an attachment component provided on each of the first and third panels, such that when the first and third panels are urged together, the display device is closed and the attachment components associate with one another, wherein the outer sides of the first and third panels are substantially aligned, and the second and fourth panels are interior to the outer sides of the first and third panels when the display device is closed.

In an embodiment, the display device may include two or more strata. There is often an interest in using display devices which make use of one's senses to hold a person's attention, or to assist in providing education or information about a particular topic. The senses that can be used to obtain and keep one's attention include sight, smell, touch, hearing, or taste. These senses can be activated with the use of various features within the display device including lighted features, fragrances-emitting features, various textures, among other possibilities. The inventors have found that making use of additional senses in relation to the display device helps to draw and maintain the attention of a user, in addition to providing an ability to highlight particular information on the display device.

### BRIEF DESCRIPTION OF THE DRAWINGS

A more particular description of the invention briefly described above will be rendered by reference to specific embodiments thereof that are illustrated in the appended drawings. Understanding that these drawings depict only typical embodiments of the invention and are not therefore to be considered to be limiting of its scope, the embodiments of the invention will be described and explained with additional specificity and detail through the use of the accompanying drawings in which:

FIG. 1 is a front side view of the display device in an open position.

FIG. 2 is a top view of the display device in a closed position.

FIG. 3 is a view of the display device at an intermediate position in between the open and the closed positions.

FIG. 4 is a front side view of the display device in an open position demonstrating various features of an embodiment of the device.

FIG. 5 is a side cross sectional view of the display device providing connections between the various components of the device.

### DETAILED DESCRIPTION

The inventors have recognized a need in the art for a portable, eye-catching novel way of conveying information using a display that is foldable and can be used for marketing or for general advertising display purposes. An important feature of the invention includes a folding display device which may be manufactured, shipped, and compactly stored in a flat, three-layer, folded, closed position for space saving reasons but which may be readily unfolded into a one layer opened position for display purposes. The device can also be used to display information during when in the folded, closed position state, as information can be displayed on the back side of the device as well as the front side of the device. The device includes a planar body including four contiguous panels which can be folded in such a way that when the device is in a closed position, two of the panels are interior to the other two panels. The device is also provided wherein a securing or attachment component is used to maintain the device in a closed position until desired by the user. Advantages of the attachment components provided herein include ease of attachment and detachment of the attachment component for quick and efficient opening and closure of the display device. The display device may further be comprised of multiple strata, wherein, for example, a first strata is disposed on a second strata, wherein the first and second strata comprise the planar body.

The term “contiguous” as used herein can be construed to mean sharing a common border, edge, or boundary, for example, with regard to panels, they can share a common border with one another to form the contiguous body. However, the panels need not be in direct contact with one another. Indirect contact between the panels is sufficient. For example, an adjoining device may be provided between the “contiguous panels”. Contiguous can also mean next or together in sequence, neighboring, or adjacent to.

Advantages of the display device include the ability to present information in an educational, informative, and entertaining manner by making use of the various senses of the user, including sight, smell, hearing, taste, and touch. For example, LED technology can be used to light one or more aspects of the device. This technology can also be used to highlight information that is of particular importance on the device.

The display device may incorporate EPD (electronic paper display) technology to provide information to a user, or may include both EPD and LED such that the device can be used in various lighted conditions. While EPD is useful in the daytime where plenty of light is available, LED light is better suited for occasions where less light is found. The use of EPD and/or LED technology is discussed in U.S. Patent Publication No. U.S. 2011/0084952 A1 by YEN. The device may be lit by any other method known in the art, and the lighting features may be disposed on any of the strata of the device so long as light provided by the lighting feature may be seen by a user of the display device. The term “strata” or “stratum” as used herein includes a layer or series of layers which form the planar body, each of which are superimposed over one another.

The lighting feature may be activated upon opening of the display device, or may be activated via a switch associated with the display device. The device may further feature a magnetic contact switch such that when in a closed position, the lighting feature is off, and when in an open position, the lighting feature is on. The magnetic switch may also be the attachment component in an embodiment. The display device may include a battery, a switch, a processor, and LED/EPD. All of the components of the display device may be electrically connected as necessary to provide an integrated system.

A scent-emitting member can be included in one embodiment of the device, wherein it is used to attract the attention of a user. The scent-emitting member can be provided on or within the display device, affixed to or positioned on one of the strata of the device, at least one stratum of the device may be impregnated with a scent-emitting member, or the scent-emitting member may be associated with the display device by any other method know in the art. The scent-emitting member may be visible or non visible to a user of the device. The scent-emitting member can be activated to dispense a fragrance to the user either upon opening or closing of the display device. Alternatively, the scent-emitting member can dispense a fragrance in the area generally surrounding the display device at a constant rate for a predetermined time period.

There may be an activation switch which controls the dispensing of the fragrance from the device. Other embodiments include a scent-emitting member affixed to the innermost or outermost stratum of the display device, wherein a cover over the scent-emitting member is affixed to the member and wherein upon removal or opening of the cover, a fragrance from within the scent-emitting member is released. The scent-emitting member may be embodied as in U.S. Pat. No. 4,802,626 issued to Forbes et al., or as in U.S. Pat. No. 6,643,967 issued to Bloom, for example.

The display device may further include a heating element coupled to the scent-emitting member, such that upon heating by the heating element, the scent-emitting member gives off a fragrance to the user of the device. The heating element is coupled to a power source which may be disposed on the polymeric body (embodied as an onboard battery, for example) or attached to one of the stratum thereon, for example. The heating element and scent-emitting member may be embodied as found in U.S. Pat. No. 4,339,079 issued to Sato et al., or as in U.S. Pat. No. 2,991,517 issued to Bundy et al., or as otherwise known in the art. Emission of the fragrance from the scent-emitting device can occur upon activation of heating member, upon opening or closing of the display device, by an operation switch, based on a pre-determined time release schedule, or the fragrance may be continuously released from the scent-emitting member.

An audio device may be included in the display device, whereby pre-recorded audio can be played, or otherwise an audio may be recorded on the audio device of the display device by a user for later playback. For example, see U.S. Patent Publication No. 2012/0011751 A1 (Schimke et al.). The audio device may be coupled to the planar body and may be configured for receiving audio information and playback. The audio device may include a speaker, a connector capable of receiving audio information, a power source, and a first element on a user interface either on or associated with the display device for initiating an audio information playback. The audio information may be any pre-recorded message of the audio device or may be input by the user of the device.

In another embodiment, the audio information received by the audio device is automatically played when the display device is in the open position. The audio information may be automatically played when the display device is in the closed position.

The display device further includes a microphone for receiving a recording from a user, and a second element on the user interface for initiating a recording of audio information by the user.

In an embodiment of the invention, the body of the display device will be of a planar, flexible, synthetic polymeric material, and the display zone will be defined by at least one major surface of the body. In another embodiment, at least a portion or a panel of the display device will be of a non-flexible material. For example, four individual panels which are joined together on at least two sides of each panel may form the display device, however at least two of the panels may be formed of a non-flexible material, wherein the remaining two panels are of a flexible, synthetic polymeric material, such that the flexible panels can fold to allow the device to collapse into a closed position. Alternatively, all or none of the panels can be formed of a flexible material.

In one embodiment, portions of the planar body may be three dimensional, which may be formed by 3D relief (a technique which produces a three dimensional texture) or by any other techniques known in the art to provide a textured surface on at least one surface of the device. A further embodiment includes a display device wherein upon transitioning from a closed position to an open position, a 3D image is exposed. This three dimensional image can be wherein the device includes multiple strata, and wherein a stratum of the device is folded when the device is in a closed position such that when the device is opened, a three dimensional display is erected. The image may display important information on the display device, and by virtue of its dimension will elicit the attention of the user. The three dimensional image can be structured, for example, as is found in 3D greeting cards, see Cole, U.S. Pat. No. 5,864,793.

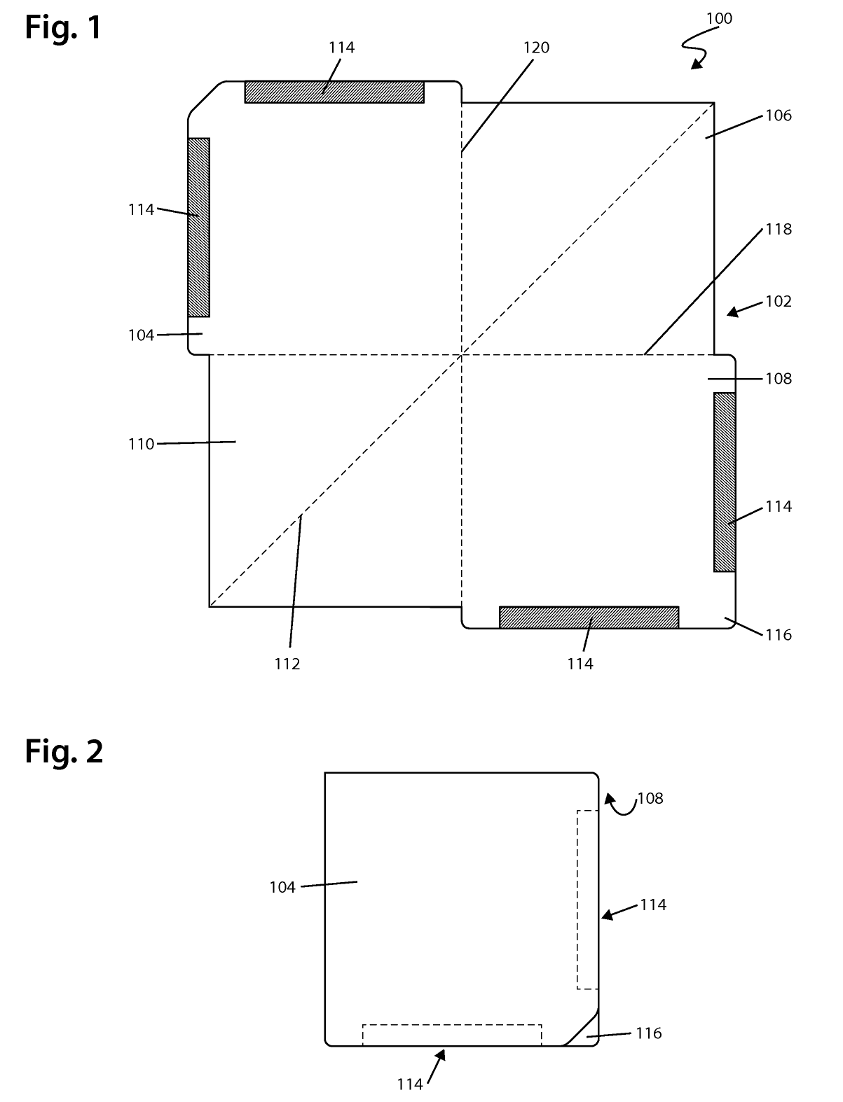

Turning to the drawings, FIG. 1 shows a front side view of the display device 100 in an open position. A planar body 102 comprises a first 104, second 106, third 108, and fourth 110 panel, collectively, the “contiguous panels”.

A diagonal fold line 112 that spans from a point between the two outer sides of the second panel 106 to a point between the two outer sides of the fourth panel 110 is presented in the Figure. A horizontal fold line 118 is disposed between the contiguous panels, providing a fold line between the first and second panels 104, 106 from the third and fourth panels 108, 110. A vertical fold line 120 is disposed between the contiguous panels, providing a fold line between the first and fourth panels 104, 110, and the second and third panels 106, 108. An attachment component 114 is provided on the front side of the first and third panels 104,108. Preferably the attachment component will be integral with the planar body, and will be in the form of at least one protrusion or attachment component formation which is shaped and positioned so as to be engageable with at least one complementary formation on the opposing panel. The attachment component can be in the form of Velcro, magnet, adhesive, or snap-closure, or any other form of attachment known in the art. The attachment component may alternatively be in the form of laterally protruding engagement formations, such as finger like protrusions extending from the outer side of one panel and slots provided on the outer side of the opposing panel for receiving the finger like protrusions. The spacing and dimensions of the finger-like protrusions may then be matched to engage with complementary formations such as gaps or openings in or edges of the sides of the opposing panel. Two attachment components are shown on each of the first and the third panels 104, 108, however any number of attachment components may be provided on each panel so long as they are provided in an orientation so as to allow a connection between the first and third panels, 104 and 108, respectively. There must be at least one attachment component on each of the first and second panels.

Information for advertisement or education can be displayed on the front side or the back side of the planar body 102, on all or some of the panels. In order to facilitate effective closure of the display device, the second and fourth panels 106, 110, are provided with a smaller height and width than the first and third panels 104, 108, and the attachment component 114 on the first and third panels 104, 108, are provided on the outer edges of the panels. When the display device 100 is in a closed position, the second and fourth panels 106, 110 are folded along the diagonal fold line 112, and the first and third panels 104, 108 are folded along the vertical 120 and horizontal 118 fold lines such that outer sides of the second and fourth panels 106, 110 are interior to the outer sides of the first and third panels 104, 108 when the device 100 is in the closed position.

FIG. 2 is a top view of the display device 100 in a closed position. The planar body 102 is folded along the vertical 120, horizontal 118, and diagonal 112 fold lines, showing the display device 100 in the closed position. The attachment components 114 are shown with dotted lines, as they are located between the first panel 104 and the third panel 108. In the closed position, the tab 116 formed at a point between the two outer sides of either the first or the third panels 104, 108, is visible beneath the other of the first or the third panels 104, 108. This is due to the design of the display device 100, such that the other of the panels (without the tab) is formed wherein the corner between the two outer sides is removed. This is so that a user can separate the attachment components, and thus the panels from one another by pressing on the tab 116 and forcing it away from the removed corner of the opposing panel so as to change the display device from the closed position to the open position.

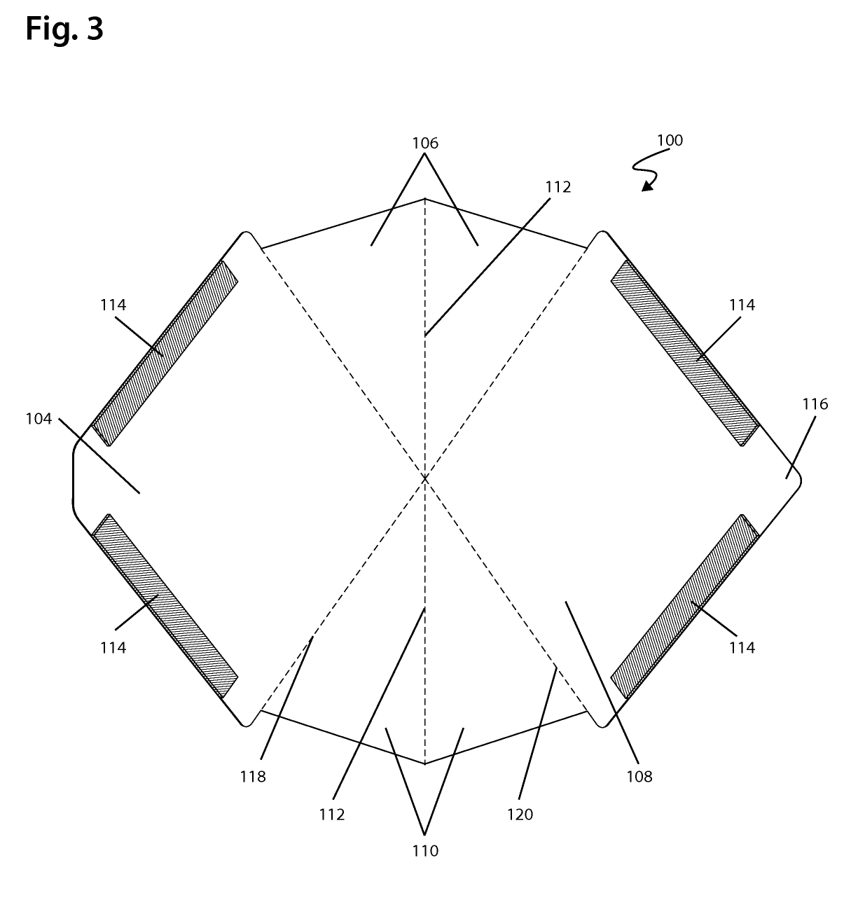

FIG. 3 is a view of the display device at an intermediate position in between the open and the closed positions. The second panel 106 and the fourth panel 110 are shown in an intermediate folding stage. The panels 104, 106, 108, 110 are folded around the diagonal, horizontal, and vertical fold lines, 112, 118, 120. The attachment components 114 are shown on the first and third panels 104, 108.

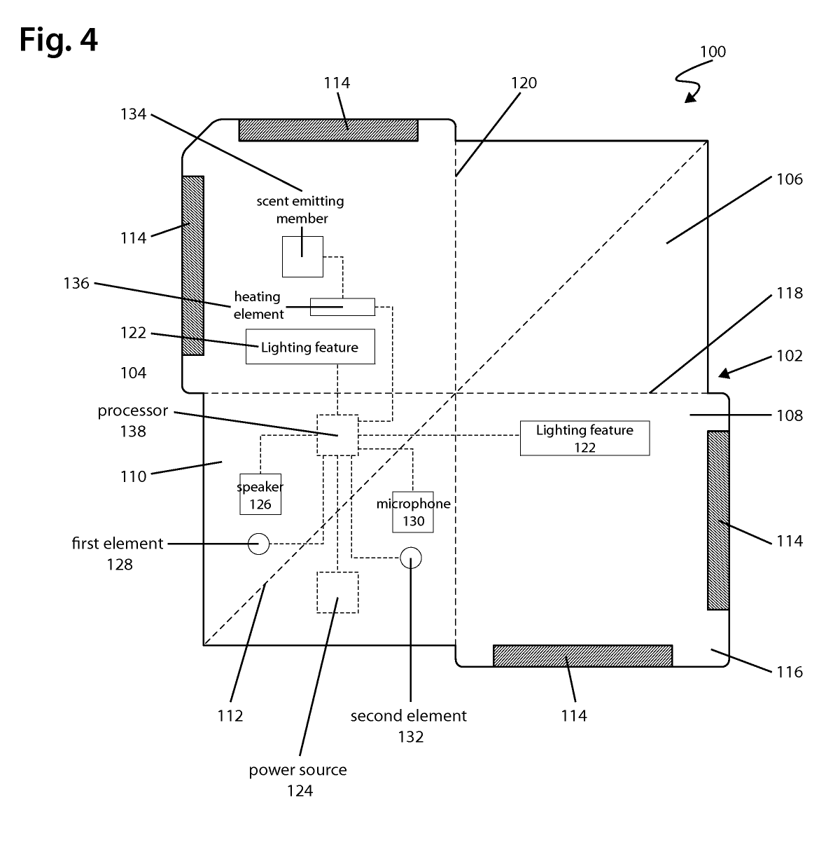

FIG. 4 provides a front side view of the display device 100 in an open position. Additionally seen in FIG. 4 are various elements of an embodiment of the device 100 including a lighting feature 122 shown on both the first and third panels of the embodiment. A power source 124 embodied as a battery in this embodiment is provided on the device 100 as well as a processor 138 shown as connected to the battery 124. A speaker 126 is shown as displayed on the fourth panel, as well as a first element 128, second element 132, and a microphone 130 connected to the battery 124 and the processor 138. Furthermore, a scent emitting member 134 is provided, as well as a heating element 136 associated with the scent emitting member 134 and connected to the battery 124. In one embodiment, the processor can be used to activate or deactivate various features of the system including the lighting features 122, however, a sensor may also be used and integrated into the system as is known in the art such that, for example, upon opening or closing of the device 100, the sensor activates the lighting features 122, for example, of the device. Other examples include activation of the scent emitting member or the heating element with the use of sensors of the system.

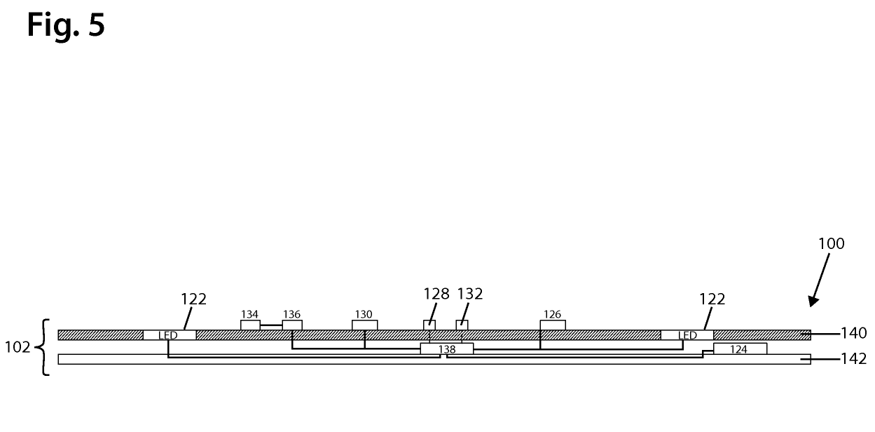

In FIG. 5, a side cross sectional view of an embodiment of the display device 100 is provided. This view shows the power source 124 disposed between a first strata 140 and the second strata 142 of the device 100. The power source 124 is electrically connected via circuitry to the various components of the device 100 as necessary to provide an integrated system.

The display device is formed of any material known in the art which allows the foldability of the indicated portions of the device as well as structural support for the display device to allow it to function as intended, to display information as described above. Examples of materials of which the display device may be created include but are not limited to: paper, metal, plastic, cardboard, fabric, or any combination thereof, and any variations known to those of ordinary skill in the art which would serve the same function.

While certain embodiments of the present invention have been shown and described herein, such embodiments are provided by way of example only. Numerous variations, changes and substitutions will occur to those of skill in the art without departing from the invention herein. Accordingly, it is intended that the invention be limited only by the spirit and scope of the appended claims. It also should be borne in mind that all patents, patent applications, patent publications, technical publications, scientific publications, and other references referenced herein are hereby incorporated by reference in this application in order to more fully describe the state of the art to which the present invention pertains.

What is claimed is:

1. A display device, comprising:
an open position;
a closed position;
a planar body comprising contiguous panels, comprising a first panel, a second panel, a third panel, and a fourth panel, each of the first, second, third and fourth panels comprising four sides of substantially equal length, two inner sides and two outer sides, each panel being connected at each inner side to an inner side of an adjacent panel;
the first and third panels being substantially similar in size, and the second and fourth panels being substantially similar in size, wherein the first and third panels are greater in height and width than the second and fourth panels;
the second and fourth panels each comprising a diagonal fold line extending from a point between the two outer sides to a point between the two inner sides; and
an attachment component provided on the first and third panels;
such that when the display device is in the open position, the planar body forms one layer, and when the display device is in the closed position, the planar body forms three layers, wherein the second and fourth panels fold along the diagonal fold line forming a second layer, and the first and third panels form a first layer and a third layer, respectively, and the attachment component provides for attachment between the first and third layers.

2. The display device of claim 1, wherein when the display device is in the closed position, the outer sides of the planar body line up with one another.

3. The display device of claim 1, wherein a point between the outer sides of either the first or the third panel forms a tab, and a point between the outer sides of the other of the first or the third panel is removed, such that when the device is in the closed position the tab can be used to separate the first and third panels and place the device in the open position.

4. The display device of claim 1, wherein the attachment component comprises Velcro, magnet, adhesive, and/or snap-closure.

5. The display device of claim 1, wherein the planar body comprises at least a first strata and a second strata.

6. The display device of claim 1, wherein a scent-emitting member is disposed on the planar body, wherein the scent-emitting member dispenses a fragrance to a user upon activation of the scent-emitting member.

7. The display device of claim 6, wherein activation occurs upon opening and/or closing of the display device.

8. The display device of claim 6, wherein the scent-emitting member is coupled to a heating element, said heating element being coupled to a power source, wherein upon actuation of the heating element, a fragrance is emitted from the scent-emitting member.

9. The display device of claim 8, wherein actuation of the heating element occurs upon opening and/or closing of the display device.

10. The display device of claim 1, further comprising at least one light emitting member.

11. The display device of claim 10, wherein the at least one light emitting member comprises light emitting diode (LED) and/or electronic paper display (EPD).

12. The display device of claim 10, wherein the at least one light emitting member is actuated by opening and/or closing the display device.

13. The display device of claim 1, further comprising an audio device coupled to the planar body, the audio device configured for receiving audio information and playback, the audio device having a speaker, a connector capable of receiving audio information, a power source, and a first element on a user interface for initiating an audio information playback.

14. The display device of claim 13, wherein audio information received by the audio device is automatically played when the display device is in the open position.

15. The display device of claim 13, further comprising a microphone for receiving a recording from a user, and a second element on the user interface for initiating a recording of audio information by the user.

16. The display device of claim 1, further comprising an audio device, the audio device comprising a speaker, wherein subsequent to placing the display device in an open position, a recording is played from the speaker of the audio device.

17. The display device of claim 1, wherein the planar body comprises a three dimensional texture.

18. A display device, comprising:
an open position;
a closed position;
a planar body comprising contiguous panels, the planar body comprising a first panel, a second panel, a third panel, and a fourth panel; and
an attachment component provided on each of the first and third panels, such that when the first and third panels are urged together to place the display device in the closed position, the attachment components associate with one another whereby the outer sides of the first and third panels are substantially aligned in the closed position of the display device, and the second and fourth panels fold, whereby the outer sides of the second and fourth panels are interior to the attachment components in the closed position of the display device.

19. A method for displaying information, comprising:
a display device comprising a planar body, the planar body comprising contiguous panels, comprising a first panel, a second panel, a third panel, and a fourth panel, an attachment component provided on each of the first and third panels, such that when the first and third panels are urged together, the display device is closed and the attachment components associate with one another, wherein the outer sides of the first and third panels are substantially aligned, and the second and fourth panels are interior to the outer sides of the first and third panels when the display device is closed.

20. The method of claim 19, wherein the planar body further comprises a light-emitting member to highlight information being displayed.

21-25. (canceled)
